(19) United States
(12) Patent Application Publication
(10) Pub. No.: US 2026/0216583 A1
(43) Pub. Date: Jul. 30, 2026

(54) APPARATUS FOR MEASURING GOLF DISTANCE AND METHOD FOR MEASURING GOLF DISTANCE

(71) Applicant: R2G PEOPLE CO., LTD, Suwon-si (KR)

(72) Inventor: Namjin Jeong, Suwon-si Gyeonggi-do (KR)

(21) Appl. No.: 19/576,440

(22) Filed: Mar. 24, 2026

Related U.S. Application Data
(63) Continuation of application No. PCT/KR2023/018791, filed on Nov. 21, 2023.

(30) Foreign Application Priority Data
Sep. 27, 2023 (KR) 10-2023-0130534

(51) Int. Cl. A63B 71/06; A63B 57/00; G01S 19/19

(52) U.S. Cl. CPC A63B 71/0622; G01S 19/19; A63B 57/00; A63B 2071/0691; A63B 2220/12; A63B 2220/20

(57) ABSTRACT

The present invention relates to an apparatus for measuring golf distance, comprising: a distance measuring unit for measuring a distance between a user and a pin on a green; a user coordinate measuring unit for measuring GPS coordinates of the user; an azimuth measuring unit for measuring an azimuth at a point of the user; and a pin coordinate calculating unit for calculating GPS coordinates of the pin from the distance, the GPS coordinates of the user, and the azimuth so as to obtain accurate position information of the pin on the green, thereby providing a precise distance and position of a pin with a reduced error range since a distance from a golfer or a position where a ball has fallen to a pin is calculated even if a position of a pin is changed from time to time.

### CROSS-REFERENCE TO RELATED APPLICATION

This application is a continuation of international application number PCT/KR2023/018791 filed on Nov. 21, 2023 and claims the benefit of Korean Patent Application No. 10-2023-0130534 filed on Sep. 27, 2023 which are incorporated herein by reference in their entirety and for all purposes.

### TECHNICAL FIELD

The present invention relates to an apparatus for measuring golf distance and a method for measuring golf distance, and more particularly, to an apparatus for measuring golf distance and a method for measuring golf distance for measuring a distance at a golf course, calculating a position of a pin, and displaying the distance and position on a screen.

More particularly, the present invention relates to an apparatus for measuring golf distance and a method for measuring golf distance that use a laser distance measuring method and a GPS distance measuring method together, add a geomagnetic sensor thereto, display an accurate position of a pin on a screen of a display unit built in an apparatus for measuring golf distance of a golfer, and support an aiming direction that the golfer intends to target during a round.

### BACKGROUND

Generally, in golf, the fewer strokes during a round of 18 holes or more act as a decisive factor in achieving a successful game result. However, in order for a golfer to recognize specific distance information within a course, the golfer has no choice but to rely on his or her own distance sense, or to obtain information on an approach distance and a position of a pin by depending on advice of an experienced person or a caddy. In such a case, accuracy of the approach distance is poor, and in the case of a novice golfer, calculating a distance itself is also difficult. In addition, in a majority of golf courses overseas such as the United States, Europe, and Japan, and some golf courses in Korea, rounds are performed as no-caddy, so that difficulties and confusion are further felt in game progress.

The best way to reduce a score in golf is in approaching the green, and in order to properly approach a green, there is a method of grasping an accurate distance and position to a pin and placing the ball as close to the pin as possible.

Recently, as people enjoying golf form various user groups without boundaries of age and gender, interest in and demand for a system for a playing strategy capable of reducing a score or a golf distance measuring terminal for convenient and smooth game progress are increasing. A laser-type distance measuring terminal or a GPS-based distance measuring terminal is a device sought by many golfers.

However, since such a golf distance measuring terminal provides information on an approach distance based on a pin on which a hole cup position information providing device is installed, it is difficult to predict an actual distance and direction from a position of a golfer, and a position of a pin on a green can be grasped on a downhill slope golf course, but a method of grasping a position of a pin on a green is limited on a course where a position of a pin is at eye level or on an uphill course.

In addition, in an existing golf course, a position of a pin on a green can be grasped whether the pin is a front pin, a middle pin, or a back pin through a color of a flag on the pin, but this is insufficient to obtain information on an accurate position of a pin.

### Patent Document

(Patent Document 1) Korean Registered Patent No. 10-2245567

### SUMMARY

### Technical Problems

The present invention has been proposed to solve the above problems, and an object aspect thereof is to provide an apparatus for measuring golf distance and a method for measuring golf distance that combine a laser distance measuring method and a GPS distance measuring method and additionally use geomagnetic sensor technology so as to enable a golfer to obtain approach information of a golf course to approach, and display on a screen an accurate distance from a current position of a golfer to a pin, position information of a pin, and also an aiming direction toward which the golfer aims.

In addition, the present invention is to provide an apparatus for measuring golf distance and a method for measuring golf distance that not only measure a distance from a point where a ball has fallen to a pin during an approach shot by a golfer, but also display on a screen an accurate position of at what point on a green a target pin is located.

### Technical Solutions

As a technical aspect for achieving the above object, an apparatus for measuring golf distance according to the present invention comprises: a distance measuring unit for measuring a distance between a user and a pin on a green; a user coordinate measuring unit for measuring GPS coordinates of the user; an azimuth measuring unit for measuring an azimuth at a point of the user; and a pin coordinate calculating unit for calculating GPS coordinates of the pin from the distance, the GPS coordinates of the user, and the azimuth so as to obtain accurate position information of the pin on the green.

Preferably, the apparatus further comprises: a data unit including GPS coordinates representing a boundary of a green of a golf course; and a display unit for displaying, on a screen, the green and a position corresponding to GPS coordinates of the pin.

More preferably, the user coordinate measuring unit measures GPS coordinates of the user on the green.

More preferably, the data unit includes undulation information of the green, and the display unit displays on the screen the undulation of the green and a position corresponding to the GPS coordinates of the user on the green to assist putting of the user.

In addition, a method for measuring golf distance according to the present invention comprises: measuring a distance between a user and a pin on a green; measuring GPS coordinates of the user; measuring an azimuth at a point of the user; and calculating GPS coordinates of the pin from the distance, the GPS coordinates of the user, and the azimuth so as to obtain accurate position information of the pin on the green.

Preferably, the method further comprises: displaying the green on a screen of an apparatus for measuring golf distance from GPS coordinates representing a boundary of a green of a golf course; and displaying, on the screen of the apparatus for measuring golf distance, a position corresponding to the GPS coordinates of the pin.

More preferably, the method further comprises: measuring GPS coordinates of the user on the green.

More preferably, the method further comprises: displaying, on the screen of the apparatus for measuring golf distance, undulation of the green from undulation information of the green to assist putting of the user; and displaying, on the screen of the apparatus for measuring golf distance, a position corresponding to the GPS coordinates of the user on the green.

### Advantageous Effects

According to the apparatus for measuring golf distance and the method for measuring golf distance according to the present invention as described above, since a distance from a golfer or a position where a ball has fallen to a pin is calculated even if a position of a pin is changed from time to time, compared to a conventional GPS distance measuring type terminal that measures a distance from a center of a green, an error range is relatively low, and a precise distance and a position of a pin can be provided, and the distance and position can be immediately applied at any golf course.

Accordingly, a golfer can accurately know an approach distance and a position of a pin from a place where he or she is standing or from a ball to a pin and play the course, so that smooth game progress can be performed, and in the case of a novice golfer, by being provided with information on an accurate distance and an accurate position of a pin, a very beneficial result can be obtained also in enhancement of physical strength by enabling enjoyment of more interesting golf.

Additionally, even in the case of a no-caddy golf course, a golfer can be provided with distance information and accurate position information of a pin, so that rounding can be performed without difficulty, and caddy fees can be reduced, so that satisfaction of a golfer can be improved.

In addition, by displaying an approach distance measurement according to a remaining distance to a pin, altitude and direction, and an accurate position of a pin on a green, confirmation of a distance from a golfer to a pin and an accurate position of a pin is possible, so that it can be usefully utilized also for short-distance approach measurement within a golf course.

Additionally, a golfer can know an aiming direction toward a green that is not visible to the eye, such as on an uphill golf course, and also positions of obstacles such as penalty areas or bunkers in a direction being aimed at, through a display on an apparatus for measuring golf distance having a compass function, so that help can be given to a game.

In addition, since a direction from a position of a ball on a green to a position of a pin obtained through measurement during an approach shot is automatically indicated, a putting direction can be more easily obtained based on undulation information of a green displayed on a hole map.

### BRIEF DESCRIPTION OF DRAWINGS

FIG. 1 shows a configuration of an apparatus for measuring golf distance according to the present invention,

FIG. 2 shows a golf course on a display unit of an apparatus for measuring golf distance according to the present invention,

FIG. 3 shows an approach distance, a position of a pin, and undulation of a green on a display unit of an apparatus for measuring golf distance according to the present invention,

FIG. 4 shows GPS coordinates of a green boundary to be used in the present invention and a form of a green using positions thereof,

FIGS. 5(a) and 5(b) are drawings for a method of calculating GPS coordinates of a pin according to the present invention,

FIG. 6(a) shows a position of a golfer within a course, a position of a green, and an obstacle not visible to the eye, and FIG. 6(b) shows information of an obstacle near an aiming direction on a display unit of an apparatus for measuring golf distance according to the present invention,

FIG. 7 shows an approach distance from a ball to a pin during putting on a green and undulation of a green on a display unit of an apparatus for measuring golf distance according to the present invention, and

FIG. 8 shows a configuration of a method for measuring golf distance according to the present invention.

### DETAILED DESCRIPTION

Hereinafter, an apparatus for measuring golf distance and a method for measuring golf distance according to the present invention will be described in detail with reference to the accompanying drawings.

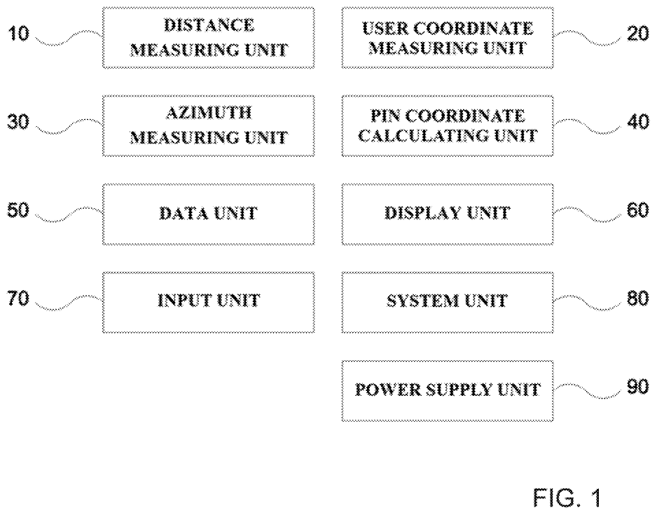

FIG. 1 is a block diagram showing a configuration of an apparatus for measuring golf distance 1 according to the present invention.

The apparatus for measuring golf distance 1 includes a distance measuring unit 10, a user coordinate measuring unit 20, an azimuth measuring unit 30, and a pin coordinate calculating unit 40.

Specifically, the distance measuring unit 10 measures a distance between a user and a pin 120 on a green 110. The distance measuring unit 10 may use, for example, a laser method. Since a user will measure at a point where a ball is located, a position of the user corresponds to a position of the ball.

Additionally, the distance between the user and the pin 120 on the green 110 may be a straight line distance, but a horizontal distance is preferable in order to accurately calculate GPS coordinates of the pin 120 by a method described below.

The horizontal distance can be calculated using a trigonometric function from a straight line distance between the user and the pin 120 measured by a laser method and an inclination angle between a horizontal plane and the straight line distance obtained by various sensors such as an acceleration sensor.

Additionally, the user coordinate measuring unit 20 measures GPS coordinates of the user, and includes a GPS sensor. In addition, the azimuth measuring unit 30 measures an azimuth at a point of the user, and includes a geomagnetic sensor.

The pin coordinate calculating unit 40 calculates GPS coordinates of the pin 120 from the distance, the GPS coordinates of the user, and the azimuth of the user obtained above so as to obtain accurate position information of the pin 120 on the green 110.

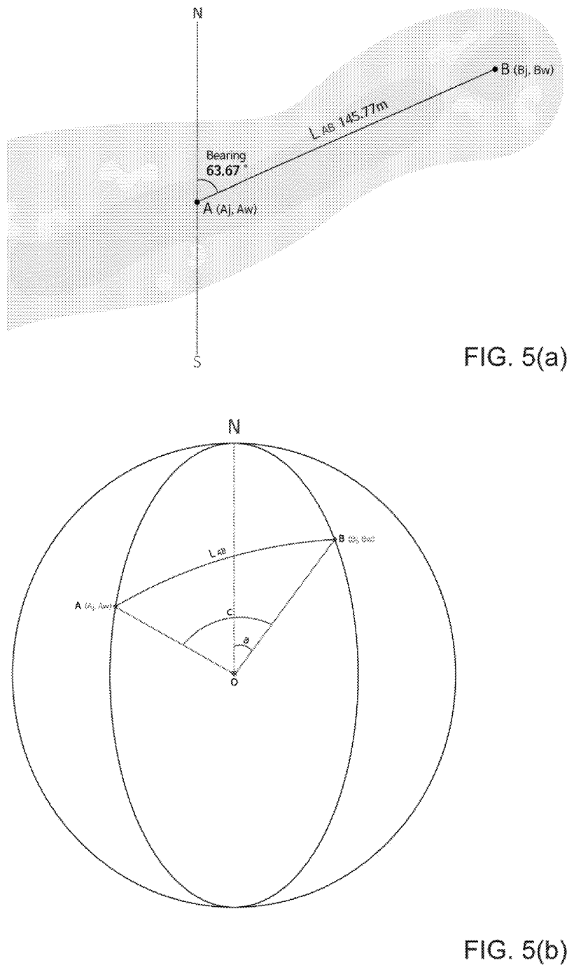

With reference to FIGS. 5(a) and (b), a method by which the pin coordinate calculating unit 40 calculates GPS coordinates of the pin 120 will be described as follows through an example of [Table 2]. At this time, Table 1 explains terms.

TABLE 1

| No. | Term | Description |
|---|---|---|
| 1 | A | Golfer position |
| 2 | B | Pin position |
| 3 | Aj | Golfer position longitude |
| 4 | Aw | Golfer position latitude |
| 5 | Bj | Pin position longitude |
| 6 | Bw | Pin position latitude |
| 7 | a | ∠BON (angle between B |
| | | and North Pole N from |
| | | Earth center) |
| 8 | C | ∠ANB (angle of A-B from |
| | | North Pole) |
| 9 | c | ∠AOB (angle of A-B from |
| | | Earth center O) |
| 10 | LAB | Measured distance |
| 11 | R | Earth radius |
| 12 | Bearing | Azimuth |
| 13 | O | Center of Earth |
| 14 | N | North Pole |

TABLE 2

| A longitude | A latitude | A→B | A→B | B longitude | B latitude |
|---|---|---|---|---|---|
| (Aj) | (Aw) | distance (m) | azimuth (°) | (Bj) | (Bw) |
| 127.186933 | 37.129461 | 145.77 | 63.67 | 127.188407 | 37.130043 |

### 1) Method of Calculating GPS Coordinates of B (Longitude and Latitude of Pin)

### \textcircled{1} Obtaining Latitude of B (Bw)

Formula: Bw=90°−a (a refers to calculation formula of \textcircled{2} below and FIG. 5(b))
Explanation: Bw=90°−∠BON (angle between B and North Pole N from Earth center, refer to FIG. 5(b))
Application: 37.130043°=90°−52.869957°

### \textcircled{2} Obtaining Longitude of B (Bj)

$$Formula : Bj = Aj + C ( C refers to calculation formula of \text{?} below and FIG . 5 ( b ) )$$

$$Explanation : Bj = Aj ( longitude of golfer position ) + ∠ ANB ( angle of A - B from North Pole )$$

$$Application : 127.188407 ° = 127.186933 ° + 0.0014737 °$$

### 2) Detailed Calculation Formulas

\textcircled{1} c is a value for obtaining a, and refers to ∠AOB, that is, an angle of A-B from Earth center O.

$$Formula : c = L / R \times 180 / π$$

$$Explanation : c = distance of A - B / radius of Earth \times 180 / π$$

$$Application : 0.00131094 ° = 145.77 m / 6371004 m \times 180 / π$$

\textcircled{2} a is a value for obtaining Bw (latitude of pin), and refers to ∠BON, that is, an angle of B and North Pole from Earth center.

$$Formula : a = arc cos ( cos ( 90 - Aw ) cos ( c ) + sin ( 90 - Aw ) sin ( c ) cos ( Bearing ) )$$

$$Explanation : a = arc cos ( cos ( 90 - latitude of golfer position ) ) \times cos ( c ) + sin ( 90 - latitude of golfer position ) \times sin ( AOB ) \times cos ( azimuth of A - B )$$

$$Application : 52.86995744 ° = arc cos ( cos ( 90 - 37.129461 ° ) ) \times cos ( 0.00131094 ° ) \times sin ( 90 - 37.129461 ° ) \times sin ( 0.00131094 ° ) \times cos ( 63.67 ° )$$

\textcircled{3} C is a value for obtaining Bj (longitude of pin), and refers to ∠ANB, that is, an angle of A-B from North Pole.

$$Formula : C = arc sin ( sin ( c ) \times sin ( Bearing ) / sin ( a ) )$$

$$Explanation : C = arc sin ( sin ( ∠ AOB ) \times sin ( azimuth of A - B ) / sin ( ∠ BON ) )$$

$$Application : 0.001473703 ° = arc sin ( sin ( 0.00131094 ° ) \times sin ( 63.67 ° ) / sin ( 52.86995744 ° ) )$$

Explaining the above example in detail, when a golfer goes to a point where his or her ball has fallen and first lifts an apparatus for measuring golf distance 1 and measures a distance to a pin 120, a horizontal distance between the ball and the pin 120 can be secured. In the example, a distance is measured on GPS coordinates where a golfer having a longitude of 127.186933° and a latitude of 37.129461° is located.

Next, simultaneously with measuring a distance from a current position of a golfer or from a ball to a pin 120, an azimuth measured through a geomagnetic sensor in an apparatus for measuring golf distance 1 can be obtained. In the example, when measuring a distance from GPS coordinates where a golfer is located to a pin 120 through an apparatus for measuring golf distance 1 being carried, the distance is 145.77 m and the azimuth is 63.67°.

Next, GPS coordinates where a pin 120 is located can be obtained through a measured horizontal distance and an azimuth obtained through a geomagnetic sensor. In the example, when a horizontal distance of 145.77 m is drawn based on an azimuth of 63.67° from a point where a golfer is located (longitude: 127.186933°, latitude: 37.129461°), GPS coordinates (longitude: 127.188407°, latitude: 37.130043°) of a point where a pin 120 is located can be obtained.

The apparatus for measuring golf distance 1 further includes a data unit 50 and a display unit 60.

Specifically, the data unit 50 stores GPS coordinates representing a boundary of a green 110 of a golf course.

The data unit 50 stores all information necessary for the apparatus for measuring golf distance 1, such as GPS coordinates of a golf course during a round, for example, GPS coordinates of an entire outer circumference of each course necessary for rounding by a golfer, GPS coordinates of a bunker, entire outer circumference GPS coordinates for a penalty area, and undulation information of a green 110.

Such information may be existing information that has already been measured for a golf course, or may be information newly measured using a satellite, an aircraft, a drone, or the like.

In addition, the data unit 50 also stores information from each of the measuring units 10, 20, 30 and the calculating unit 40 described above.

Additionally, the display unit 60 displays on a screen 62 the green 110 and a position corresponding to GPS coordinates of the pin 120.

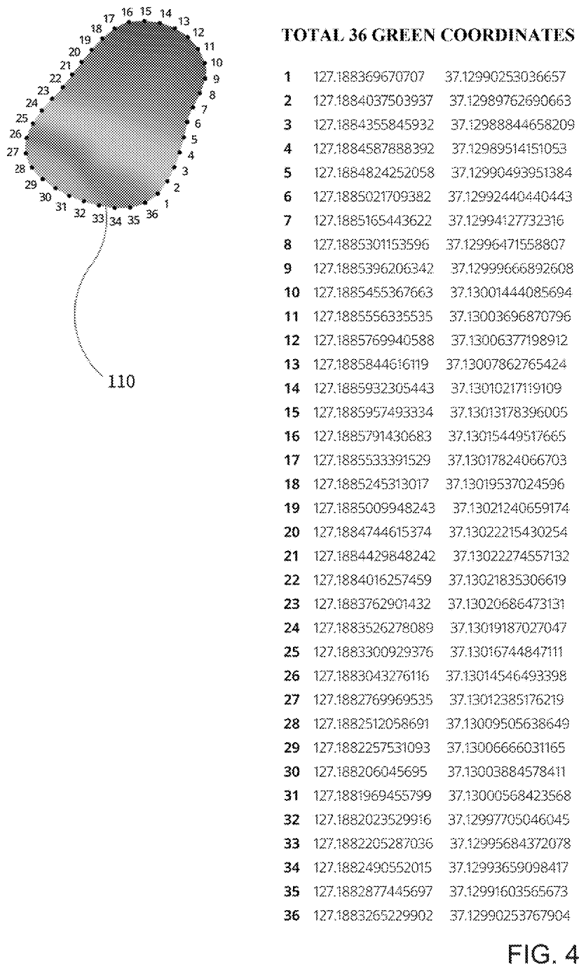

For example, the data unit 50 stores GPS coordinates representing a boundary of a green 110 on the right side of FIG. 4, and the display unit 60 connects the GPS coordinates of the green 110 and shows a form of the green 110 on a screen 62 as shown on the left side of FIG. 4.

At this time, since the data unit 50 also includes undulation information of the green 110, the display unit 60 displays undulation of the green 110 from blue for low positions to red for high positions as shown on the left side of FIG. 4.

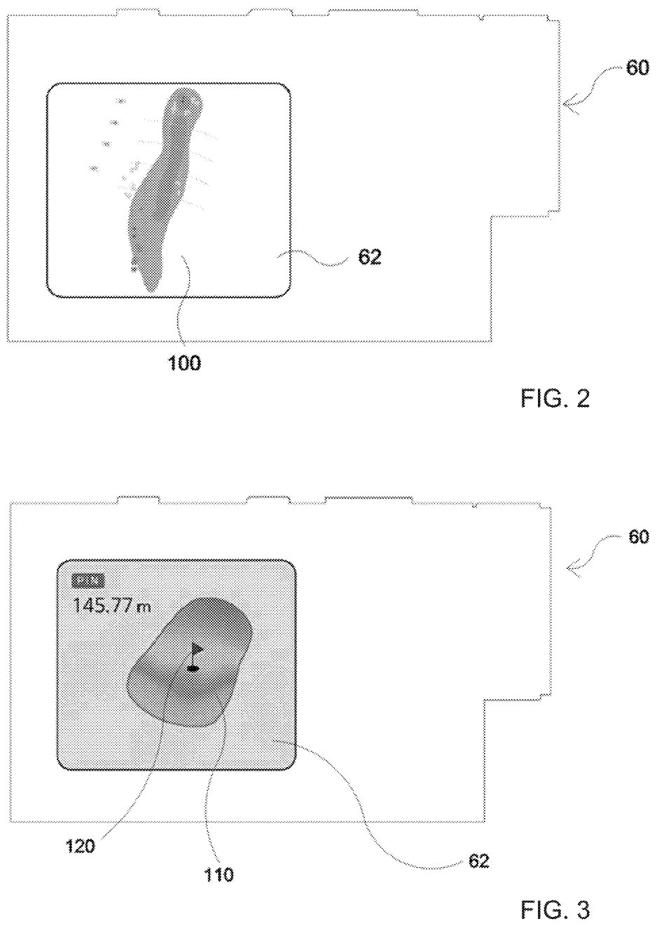

In addition to this, since the data unit 50 has GPS coordinates of the green 110 and GPS coordinates of the pin 120, the display unit 60 can accurately display the green 110 and a position of the pin 120 on the green 110 as shown in FIG. 3.

That is, it is not simply grasping roughly whether a pin 120 is a front pin, a middle pin, or a back pin, but an accurate position of a pin 120 can be grasped vertically and horizontally.

After a user puts a ball 130 on a green 110, the user goes to a point where the ball 130 has fallen, and GPS coordinates of the user on the green 110 are measured by the user coordinate measuring unit 20.

Additionally, as shown in FIG. 7, the display unit 60 additionally displays on a screen 62 the undulation of the green 110 described above and a position corresponding to GPS coordinates of the user on the green 110.

Accordingly, a user can more easily perform putting by checking undulation of a green 110, a position of a pin 120, and a position of a ball 130. Furthermore, using the above information, the screen 62 of the display unit 60 may be configured to display an approach distance and a direction from a position of the ball 130 to the pin 120.

It goes without saying that the display unit 60 can display on a screen 62 various information such as a distance to a pin 120, GPS coordinates of a pin 120, or an obstacle such as a bunker or a penalty area, in addition to the information described above.

For example, as shown in FIG. 2, the display unit 60 can display a corresponding golf course map 100 and a map of an entire golf course including the same when a golfer intends to measure a distance from the golfer to a pin 120 at a golf course.

At this time, distances are displayed on the golf course map 100 at intervals. Accordingly, an overall strategy can be easily established before a tee shot on a corresponding golf course.

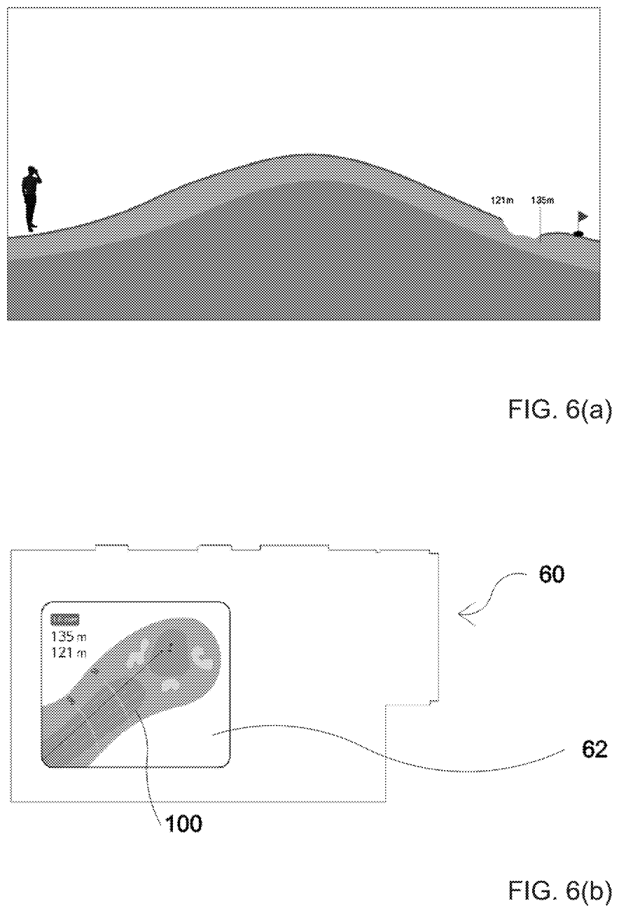

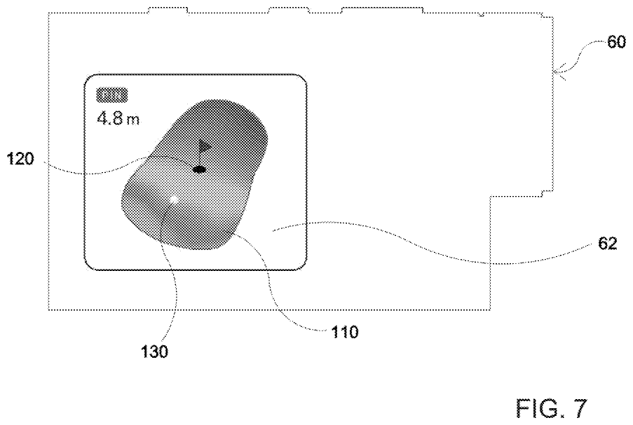

Additionally, as shown in FIG. 6(b), an aiming direction toward a green 110 not visible to the eye, such as on an uphill golf course, can be displayed on a display unit 60 of an apparatus for measuring golf distance 1 having a compass function such as a geomagnetic sensor.

At this time, when a user rotates a direction for aiming, the golf course map 100 on a screen 62 of the display unit 60 may be configured to rotate in conjunction to more easily grasp an aiming direction.

In addition, when there is a bunker not visible to the eye as shown in FIG. 6(a), information of an obstacle near an aiming direction, for example, a length of a bunker as shown in FIG. 6(b), can be displayed on the display unit 60 to help a game.

The apparatus for measuring golf distance 1 may further include an input unit 70 to which a selection of an operation of a golfer is input, a power supply unit 90 for controlling power of the apparatus for measuring golf distance 1, a system unit 80 for controlling operation of each component and between components, and the like.

Hereinafter, an actual example in which a golfer rounds using the apparatus for measuring golf distance 1 will be briefly described. A course is taken as an example of a par 4 hole.

First, before making a tee shot, a golfer checks an entire golf course map 100 displayed on a display unit 60. At this time, since distances displayed at intervals and obstacles are displayed on the golf course map 100, an aiming direction and an approach distance are set by checking these (refer to FIG. 2).

When making a second shot, an approach distance, a green 110, and a position of a pin 120 on the green 110 displayed on a display unit 60 are accurately checked (refer to FIG. 3). Optionally, an aiming direction displayed on the display unit 60 or obstacle information near it is additionally checked (refer to FIG. 6(b)).

When making putting, undulation of a green 110, a position of a pin 120, and a position of a ball 130 displayed on a display unit 60 are checked. Optionally, an approach distance or a direction from a position of the ball 130 to the pin 120 displayed on the display unit 60 is additionally checked (refer to FIG. 7).

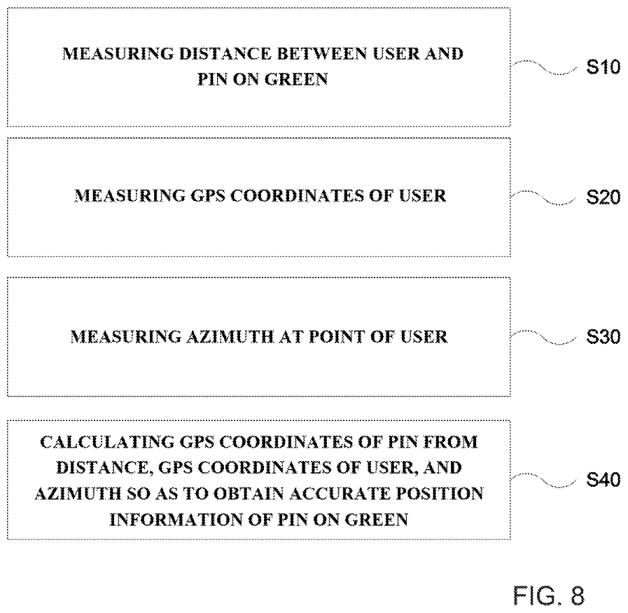

FIG. 8 shows a block diagram showing a method for measuring golf distance 2 according to the present invention. At this time, a part described in the apparatus for measuring golf distance 1 is omitted to avoid duplication.

The method for measuring golf distance 2 comprises: measuring a distance between a user and a pin 120 on a green 110 (S10); measuring GPS coordinates of the user (S20); measuring an azimuth at a point of the user (S30); and calculating GPS coordinates of the pin 120 from the distance, the GPS coordinates of the user, and the azimuth so as to obtain accurate position information of the pin 120 on the green 110 (S40).

Additionally, the method for measuring golf distance 2 further comprises: displaying a green 110 on a screen 62 of an apparatus for measuring golf distance 1 from GPS coordinates representing a boundary of a green 110 of a golf course; and displaying, on the screen 62 of the apparatus for measuring golf distance 1, a position corresponding to GPS coordinates of the pin 120.

In addition, the method for measuring golf distance further comprises: measuring GPS coordinates of the user on the green 110.

Additionally, the method for measuring golf distance further comprises: displaying, on the screen 62 of the apparatus for measuring golf distance 1, undulation of the green 110 from undulation information of the green 110 to assist putting of the user; and displaying, on the screen 62 of the apparatus for measuring golf distance 1, a position corresponding to GPS coordinates of the user on the green 110.

In the method for measuring golf distance 2, the steps mentioned above do not necessarily have to be performed sequentially.

For example, some steps may be performed simultaneously, and measuring a distance between a user and a pin 120 on a green 110 (S10); measuring GPS coordinates of the user (S20); and measuring an azimuth at a point of the user (S30) are preferably performed with each measurement being performed simultaneously.

Although the present invention has been shown and described so far in relation to specific embodiments, it is intended to clarify that those having ordinary knowledge in the art can easily understand that the present invention can be variously modified and changed within a scope not departing from the spirit or field of the present invention prepared by the following claims.

### DESCRIPTION OF REFERENCE NUMERALS

1 Apparatus for measuring golf distance
10 Distance measuring unit
20 User coordinate measuring unit
30 Azimuth measuring unit
40 Pin coordinate calculating unit
50 Data unit
60 Display unit
62 Screen
100 Golf course map
110 Green
120 Pin
130 Ball

What is claimed is:

1. An apparatus for measuring golf distance comprising:
a distance measuring unit for measuring a distance between a user and a pin on a green;
a user coordinate measuring unit for measuring GPS coordinates of the user;
an azimuth measuring unit for measuring an azimuth at a point of the user;
a pin coordinate calculating unit for calculating GPS coordinates of the pin from the distance, the GPS coordinates of the user, and the azimuth so as to obtain accurate position information of the pin on the green;
a data unit including GPS coordinates representing a boundary of the green of a golf course; and
a display unit for displaying, on a screen, the green and a position corresponding to GPS coordinates of the pin,
wherein when the user makes a shot to put a ball on the green, a real-time position of the pin is displayed on the screen, so as to enable grasping of a vertical and horizontal position of the pin on the green.

2. The apparatus for measuring golf distance of claim 1, wherein the user coordinate measuring unit measures GPS coordinates of the user on the green.

3. The apparatus for measuring golf distance of claim 2, wherein
the data unit includes undulation information of the green, and
the display unit displays on a screen the undulation of the green and a position corresponding to the GPS coordinates of the user on the green to assist putting of the user.

4. A method for measuring golf distance comprising:
measuring a distance between a user and a pin on a green;
measuring GPS coordinates of the user;
measuring an azimuth at a point of the user;
calculating GPS coordinates of the pin from the distance, the GPS coordinates of the user, and the azimuth so as to obtain accurate position information of the pin on the green;
displaying the green on a screen of an apparatus for measuring golf distance from GPS coordinates representing a boundary of the green of a golf course; and
displaying, on the screen of the apparatus for measuring golf distance, a position corresponding to the GPS coordinates of the pin,
wherein when the user makes a shot to put a ball on the green, a real-time position of the pin is displayed on the screen, so as to enable grasping of a position of the pin vertically and horizontally on the green.

5. The method for measuring golf distance of claim 4, further comprising:
measuring GPS coordinates of the user on the green.

6. The method for measuring golf distance of claim 5, further comprising, to assist putting of the user:
displaying, on the screen of the apparatus for measuring golf distance, undulation of the green from undulation information of the green; and
displaying, on the screen of the apparatus for measuring golf distance, a position corresponding to the GPS coordinates of the user on the green.
